(19) United States
(12) Patent Application Publication
(10) Pub. No.: US 2026/0170394 A1
(43) Pub. Date: Jun. 18, 2026

(54) Taxonomic Negative Sampling-Based Machine Learning

(71) Applicant: Oracle International Corporation, Redwood Shores, CA (US)

(72) Inventors: Suman Roy, Bangalore (IN); Srikant Panda, Bangalore (IN); Srijon Sarkar, Bangalore (IN); Shahid Reza, Bangalore (IN)

(73) Assignee: Oracle International Corporation, Redwood Shores, CA (US)

(21) Appl. No.: 18/978,208

(22) Filed: Dec. 12, 2024

(51) Int. Cl. G06N 20/00

(52) U.S. Cl. CPC G06N 20/00

(57) ABSTRACT

Techniques for generating negative samples using a taxonomy of entities and relations and for using the negative samples for machine learning are disclosed herein. Taxonomic negative samples are generated by selecting entities and negated relations for the entities using a taxonomy of entity types and subject, object relations. The system defines taxonomic negative samples for same-sentence relations, cross-sentence relations, and/or header context relations. The system sieves taxonomic negative samples are sieved to eliminate some samples, such as false negative samples. The sieved taxonomic negative samples are included with positive samples in training data used to train and/or fine-tune a prediction engine or other machine learning model.

### TECHNICAL FIELD

The present disclosure relates to techniques related to machine learning and training data.

### BACKGROUND

Machine learning models leverage historical data to forecast future outcomes or trends based on recognized patterns. Prediction engines, for example, leverage machine learning to analyze patterns within data, learn from these patterns, and apply the learned relationships to make predictions about unknown values or future events. However, the accuracy of a prediction engine is dependent on the samples used for training. Insufficient data prevents the model from learning meaningful patterns, leading to a phenomenon known as underfitting. Similarly, biased data sets pose a major challenge, as models trained on biased or unrepresentative data will produce biased predictions. Noisy data or imbalanced data also disrupt a model's ability to predict effectively. Prediction engines need a significant amount of representative high quality training data for effective training.

Techniques in this disclosure may address any of the aforementioned flaws, challenges, and difficulties by providing techniques that result in improved security for model output. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example machine learning system using taxonomic negative sampling, in accordance with one or more embodiments;

FIG. 2 illustrates example operations for taxonomic negative sampling, in accordance with one or more embodiments;

FIGS. 3a-d illustrate example techniques a predictive engine system using taxonomic negative sampling, in accordance with one or more embodiments; and

FIG. 4 illustrates a block diagram of a computer system in accordance with one or more embodiments.

FIG. 5 illustrates example operations for machine learning, in accordance with one or more embodiments; and

FIG. 6 illustrates a block diagram of a computer system, in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE TAXONOMIC NEGATIVE SAMPLING-BASED MACHINE LEARNING SYSTEM
3. OPERATIONS FOR TAXONOMIC NEGATIVE SAMPLING
4. EXAMPLE TECHNIQUES FOR PREDICTIVE ENGINE TRAINING USING TAXONOMIC NEGATIVE SAMPLING
i. Example Taxonomic Negative Sample Generation from Documents
ii. Example Entity and Relation Selection for and Sieving of Taxonomic Negative Samples
iii. Example Negative Sample Sieving Process
iv. Example reward model for prediction engine training and/or fine-tuning
v. Example Batch Balancing
5. MACHINE LEARNING ARCHITECTURE
6. MACHINE LEARNING OPERATIONS
7. GENERATIVE ARTIFICIAL INTELLIGENCE MODELS
8. COMPUTER NETWORKS AND CLOUD NETWORKS
9. MICROSERVICE APPLICATIONS
10. HARDWARE OVERVIEW
11. MISCELLANEOUS; EXTENSIONS

### 1. General Overview

Various types of machine learning models, such as inference models or prediction models, are trained using a training data set consisting of data points or samples. Annotated or “ground truth” data provides positive samples. However, model training using training data sets that include a balance between positive samples and negative samples produce higher quality models. Generating negative samples and using them with positive samples in training data improves the breadth of the training data set and increases accuracy and performance of a resulting model.

As disclosed herein, one or more embodiments generate negative data samples from a data source by extracting a vocabulary of entities and relations in the data source. An embodiment selects two entities for which a particular relation is not present in the data source and assigns them a negated relation [or “No-(Relation)”] to generate a negative sample. The entities are typified such that relations are valid when they occur between one or more specific types of entities. A relation is also defined as having a subject entity and an object entity for the relation. The structure of the entities'types and the subject-object nature of the relations defines a taxonomy from a set of positive samples that is used to generate negative samples from the set of positive samples.

An embodiment includes sieving the taxonomic negative samples before using the negative samples as training data. Sieving the negative samples involves evaluating the negative samples using one or more sieving rules, comparing the negative samples to a set of known positive samples, or the like. In embodiments, the sieving rules include a rule that define a negative sample to be a false negative if certain conditions are met, such as the negative sample being a false negative sample due to corresponding to a known positive sample in an internal knowledge base and/or external data source. Sieving false negatives further improves the accuracy and performance models trained using the negative samples.

Applicant notes that this Overview is non-limiting in nature, and that additional embodiments and related combinations of features are described in this Specification and/or recited in the claims.

### 2. Example Taxonomic Negative Sampling-Based Machine Learning System

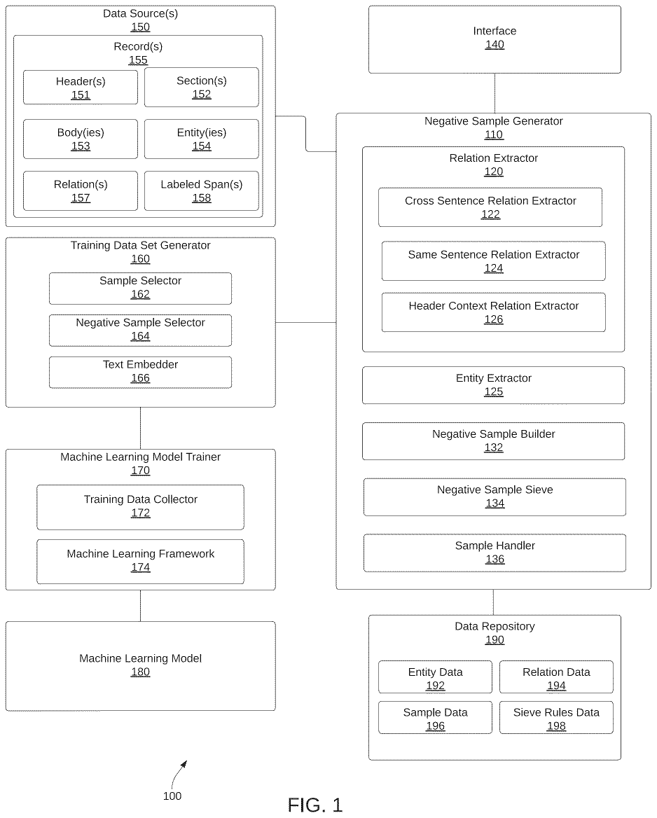

FIG. 1 illustrates an example machine learning system 100 using taxonomic negative sampling, according to embodiments. As shown, the machine learning system 100 includes a negative sample generator 110, an interface 140, one or more data sources 150, a training data set generator 160, a machine learning model trainer 170, a machine learning model 180, and a data repository 190.

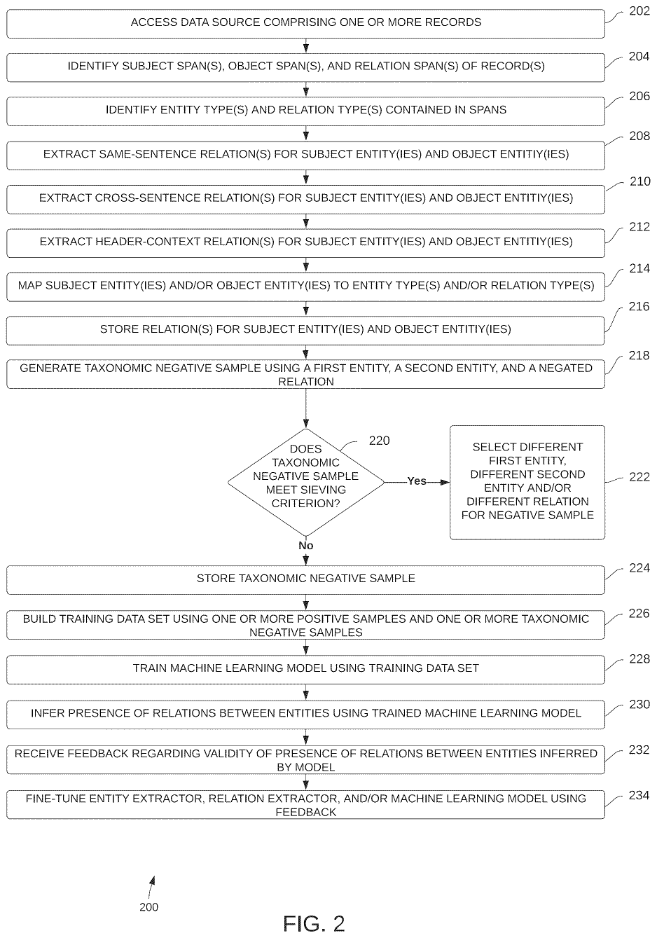

In FIG. 2, the negative sample generator 110 includes a relation extractor 120, an entity extractor 125, a negative sample builder 132, a negative sample sieve 134, a sample handler 136. The relation extractor 120 includes one or more extractors for extracting particular kinds of relations from a data source (e.g., a document or record). In the example, the relation extractor 120 includes a same-sentence relation extractor 122, a cross-sentence relation extractor 124, and a header context relation extractor 126. In embodiments, the relation extractor 120 includes additional and/or different extractors for extracting one or more other kinds of relations.

In the example, the same-sentence relation extractor 122 includes modules, algorithms, models, and/or schemas that parse entities and relations from spans comprising a sentence. For example, the same-sentence relation extractor determines a subject, object, and relation between the subject and object in a sentence. The relation extractor defines the subject entity based on the subject span of the sentence and the object entity based on the object span of the sentence. The relation is determined based on the language of the sentence connecting the subject and object.

The cross-sentence relation extractor 124 includes modules, algorithms, models, and/or schemas that parse entities and relations from spans comprising more than one sentence. For example, a cross-sentence relation extractor parses five sentences, using a window of two sentences around a reference sentence, to determine entities that are objects for an entity that is the subject of the reference sentence and/or to determine relations between the objects and the subject.

The header context relation extractor 126 includes modules, algorithms, models, and/or schemas that parse entities and relations from spans comprising at least a portion of a header and at least a portion of a body. For example, a header context relation extractor parses a header and a body for the header, to determine entities that are objects in the body for an entity that is the subject of the header and/or to determine relations between the objects in the body and the subject of the header.

The entity extractor 125 include modules, algorithms, models, and/or schemas that parse records, documents, text, or other data to determine entities contained within the data. In various embodiments, the entity extraction includes one or more rules systems, statistical analysis systems, or machine learning models. For example, Conditional Random Fields (CRFs), neural networks, and/or transformer (e.g., bidirectional encoder representations from transformers, or “BERT”) models identify entities in chunks of input text based on the parameters of the models and/or the training of the models. Various public domain models and/or private models may be suitable for extracting entities from records, documents, or text, or other data. In a particular embodiment, the entity extractor includes a list of known entities associated with a standardization or standardized format of a set of records. For example, a set of medical records is standardized according to a list of features for a clinical narrative. Items associated with the narrative that are allowed by the standardized format are identified and used as a basis for extracting matching (or similar) items from the records (or other documents, text, or data).

The negative sample builder 132 includes modules for accessing a set of entities and/or one or more relations and building a negative sample from the set of entities and the one or more relations. The negative sample builder 132 comprises functions or instructions that define a negated relation as a negative of an extracted relation. The negated relation has an entity type for a subject of the negated relation that is the same as the extracted relation and/or has an entity type for an object of the negated relation that is the same as the extracted relation. The negative sample builder 132 includes instructions to determine two entities for which the relation is not present in the positive samples. In embodiments, negative sample builder 132 includes a module for selecting a first entity matching a subject type of the relation and a second entity matching an object type of the relation.

The negative sample sieve 134 includes modules for sieving taxonomic negative samples, such that the sieved samples are not included in a training data set. The taxonomic negative sample sieve 134 comprises functions for evaluating negative samples to validate, invalidate, and/or filter the taxonomic negative samples. The modules include functions that access a taxonomic negative sample and evaluate the first entity, the second entity, and/or the relation of the taxonomic negative sample to determine if a set of rules indicates that the relation is valid for the first entity and/or the second entity.

The sample handler 136 includes modules for performing various operations on the samples, including but not limited to storing the samples, accessing the samples, loading the samples, deleting the samples, performing clustering and/or other analysis on the samples, or the like. In various embodiments, the interface 140 facilitates interaction between the negative sample generator and one or more devices, as described further below.

In FIG. 1, the sample data source 150 consists of one or more records 155, such as a medical record or other document. In the example, a record 155 includes one or more headers 151, sections 152, bodies 153, entities 154, relations 157, and/or labeled spans 158. Headers 151 provide a textual context to specific parts of the document corresponding to one or more sections of a body. Sections 152 divide the document into discrete components, organizing related information into logically connected segments. Structured documents include any number of sections, sub-sections, sub-sub-sections, and so forth. Various headers and/or section names include history, findings, assessment, symptoms, results, allergies, medications, notes, referrals, etc. Bodies 153 contain a primary text and/or a descriptive content of the structured document. Entities 154 represent objects, places, concepts, individuals, or the like mentioned within the document. Relations 157 capture how entities 154 are connected to one another. Labeled spans 158 denote portions of the text associated with specific entities or relations. In some embodiments, the sample data source includes one or more unstructured documents in addition to or instead of the one or more records 155.

Training data set generator 160 consists of a sample selector 162, a negative sample selector 164, and a text embedder 166. Sample selector 162 identifies positive data samples from sample data source 150. Negative sample selector 164 identifies negative samples. The negative samples and the positive samples are included in a training data set. The training data set contains diverse data due to including both positive and negative samples as compared to a training data set containing only positive samples. Text embedder 166 converts the selected data samples into numerical embeddings.

A machine learning model trainer 170 contains a training data collector 172 and a machine learning framework 174. Training data collector 172 gathers the samples provided by the training data set generator 160, collecting both positive and negative samples. For example, the machine learning framework 174 applies learning algorithms to collected data, training the machine learning model 180 by defining and/or adjusting various parameters. The framework processes the data iteratively, using the positive and negative samples to fine-tune the model's performance. Continuing the example, a machine learning model using such framework deploys a “SoftMax” layer to predict the existence of a relation for a pair of spans. The spans are mapped to respective entity types using binary classification to predict the existence or non-existence of a relation between the two mapped spans. The SoftMax layer is a layer which converts a feedback score to a normalized probability distribution that is scaled and/or real-valued based. The prediction and feedback about the prediction are provided as input to the SoftMax layer iteratively, to improve predictions by the machine learning model for the existence of a relation for a pair of spans.

A machine learning model 180 refers to various models trainable by machine learning model trainer 170. Such models use the patterns and relationships learned from the training data set to predict, classify, or make inferences regarding new data. The model operates by processing inputs through a learned structure and adjusting its outputs based on the data representations learned during the training process.

Generally, the data repository 190 stores data loaded onto the negative sample generator 110. The data repository 190 optionally stores data loaded from other sources. In various embodiments, the data repository 190 stores one or more types of data including, but not limited to, entity data 192, relation data 194, sample data 196, and sieve rules data 198.

The entity data 192 includes data related to entities, such as entity names, entity types, rules for identifying entities, and the like. The entity data includes entity data loaded from a record 155 corresponding to an entity 154, and/or data from another data source.

The relation data 194 includes data related to relations, such as relation names, required types for the relations, and so forth. The relation data includes relation data loaded from a record 155 corresponding to a relation 157, and/or data from another data source.

The sample data 196 includes data related to positive and/or negative samples accessed by or generated by the system 100. The sample data includes sample data loaded from a record 155 corresponding to one or more entities 154 and/or one or more relations 157, and/or data from another data source.

The sieve rules data 198 includes rules and/or a knowledge base. The rules are used to determine when a negative sample should not be included as training data. The knowledge base includes a repository of positive samples and is used as a basis of comparison for excluding certain taxonomic negative sample from being included in a training data set, such as due to the taxonomic negative sample matching a positive sample of the knowledge base. In some examples, records from an external data source are parsed for positive samples and/or loaded into the knowledge base.

In an embodiment, the negative sample generator 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, the interface 140 refers to hardware and/or software configured to facilitate communication between a user and a system. In FIG. 1, an interface 140 is used to facilitate communication between the negative sample generator 110, and/or one or more client computing devices. Such an interface 140 renders user interface elements and receives input via user interface elements. Examples of interfaces include a graphical user interface (“GUI”), a command line interface (“CLI”), a haptic interface, and a voice command interface. Examples of user interface elements include checkboxes, radio buttons, dropdown lists, list boxes, buttons, toggles, text fields, date and time selectors, command lines, sliders, pages, and forms. In various embodiments, different components of such an interface are specified in different languages. The behavior of user interface elements is specified in a dynamic programming language such as JavaScript. The content of user interface elements is specified in a markup language, such as hypertext markup language (“HTML”) or extensible markup language (“XML”) User Interface Language (“XUL”). The layout of user interface elements is specified in a style sheet language such as Cascading Style Sheets (“CSS”). Alternatively, interfaces may be specified in one or more other languages, such as Java, C, or C++.

### 3. Operations for Taxonomic Negative Sampling

FIG. 2 illustrates example operations for a method 200 of taxonomic negative sampling. For example, the method is performed by a system such as the machine learning system 100 of FIG. 1.

The system accesses a data source comprising one or more records (Operation 202). For example, the system retrieves one or more records, documents, or other files from the data source and loads them onto a component of the system. For example, the system retrieves a set of structured or unstructured data such as a set of records, documents, and/or other text. In various examples, the records are medical records, standardized medical records, or other standardized or unstandardized records.

The system identifies one or more subject entity spans, object entity spans, and relation spans of the one or more records (Operation 204). In this example, the system detects and isolates sections of text that correspond to portions of the text identified as including object entities and subject entities. The system performs this by using models and/or predefined rules or algorithms to parse the text and locate specific sections of the text where a subject or an object occurs in sentences or other chunks of the text. For example, natural language processing (NLP) is used to classify spans of text corresponding to the subject of the sentence, the object of the sentence and/or a span of the text including language describing the relation between one or more subjects and one or more objects of the sentence. The system identifies specific entity spans and relation spans within a given corpus of text.

The system identifies one or more entity types and/or relation types contained in the spans (Operation 206). In an embodiment, the system identifies a subject entity having a first entity type, an object entity having a second entity type, and a relation having a first relation type contained in one or more spans of a sentence. In embodiments, a dictionary or list of entities and/or relations is used to extract entities and/or relations that match or are similar to items in the dictionary or list. In some embodiments, the system applies a predefined template, list, or schema. For example, the system access a list of entity types that are included in a particular standardized format and identifies the presence in the data set of entities that are of a type on the list of entity types. In various embodiments, entities include people, places, organizations, dates, names, symptoms, and/or other miscellaneous objects. In embodiments, the system accesses a list of relations and identifies the presence of relations between entities in the records that are of a type on the list of relation types. In various embodiments, relations include employee of, subsidiary of, duration of, location of, anatomical site of, treatment for, severity type of, adverse to, and/or other miscellaneous relationships. In some embodiments, the system determines relationships and entities within the text using a language model.

The system extracts same-sentence relations for subject entities and object entities (Operation 208). In this example, the system examines sentences where both subject and object entities occur together. The system then determines the relationship between them, extracting relations within the same sentence. For example, a sentence in a record states that Entity A has Relation A with Entity B. A positive sample is generated from the record by defining sample from the sentence using Relation A, Entity A and Entity B.

The system extracts cross-sentence relations for subject entities and object entities (Operation 210). For example, the system identifies relationships between subject and object entities that span across multiple sentences. The system tracks the occurrences of entities through text and extracts relation data based on these connections. In another example, cross-sentence information is used to extract relations in the body of context for a section. With cross-sentence extraction, a relation is created between a subject-entity span in a sentence (also called reference sentence) and an object-entity span which is present within a number of sentences N to the right and/or to the left of the reference sentence. In this example, both sentences appear in the context of a section, although in other examples a plurality of sentences appear in a plurality of sections for a header. For example, the number of sentences N determines the size of a window as 2N+1 sentences of context.

The system extracts header-context relations for subject entities and object entities (Operation 212). The system examines the context provided by document headers, section titles, or similar structures and establishes relationships between the subject and object entities based on this context. The system leverages the additional context from headers to enhance entity relationship accuracy. In this example, a header comprises text including Entity A and Relation A. A body corresponding to the header includes a sentence that Entity B has Relation B with Entity C. A sample is generated from the header and body by selecting Relation A, Entity A, and Entity B.

The system maps entity types and relations to object entity and subject entity spans (Operation 214). In this case, the system aligns the identified types and relations with the text of the object entity and the text of the subject entity found in the spans. The system extracts the subject entity name from the subject entity span and/or the object entity name from the object entity span. The system identifies relations in the text and generates positive samples based on subject entities, object entities, and the identified relations.

In various examples, a relation is type-specific, such that only entities of one or more certain types can be selected for the relation. One example of this is for a relation (e.g. “ITEM_IS_LOCATED”) that tells a location for an item, such as an object or person. In this example, item type entities are selected for the first entity and location type entities are selected for the second entity. In various embodiments, a list of defined relations includes one or more relations for which one or more entities are of a particular type or types.

In an embodiment, the system deploys a span-based relation prediction framework whereby a span is defined as a sequence of words occurring together in a sentence. A span is mapped to an entity type or to no entity. In an embodiment, a span is mapped to an entity type picked from a list of entity types (i.e. a list such as a Medical Data Annotation Guideline defining medical terminology having entities and relations between entities). In some embodiments, if no entity picked from the list is present or able to be assigned to a span, then the span is mapped to ‘null entity’.

For example, for text “the patient is advised Telmisartan for hypertension” a span mapping can be as follows: patient maps to ROLE; Telmisartan maps to MEDICINE_NAME, hypertension maps to DIAGNOSIS. The remaining spans(e.g., is, is advised, . . . , etc.) are assigned to ‘null entity’.

The system stores relations for subject entities and object entities (Operation 216). In this example, the system records the extracted relation and entity data. The stored information includes the subject and object entity spans, their identified types, the extracted entity texts, and/or the extracted relations. In various embodiments, relations with null entities are stored for generating taxonomic negative samples and/or discarded and not used for generating taxonomic negative samples.

The system generates a taxonomic negative sample using a first entity, a second entity, and a negated relation (Operation 218). In embodiments, the system generates the taxonomic negative sample using a first entity of a first type, a second entity of a second type and a relation for the first type and the second type that is not present for the first entity and the second entity in the records (e.g., for which no corresponding relation has been stored). The system negates the relation to define the negative sample having the first entity, the second entity, and a “No-” relation between the first entity and the second entity.

In some embodiments, taxonomic negative samples are generated using entities from a selection of one or more of a header, a sentence in a body in the scope of a header; across sentences in a body in the scope of a header, etc. An example taxonomy of negative samples includes negative samples generated from same sentence entities, negative samples generated from header context entities, and/or negative samples generated from cross-sentence entities. Extracting a taxonomic negative sample of these different types facilitates defining more relations and reduces relations being missed during extraction from the data. In embodiments, the taxonomic negative samples are randomly generated by randomly selecting one or more entities that have a valid entity type for a subject and/or object of a relation.

In the example, a No-(Relation) is generated for a first entity and a second entity based on selecting a relation from the extracted relations that is not present for the first entity in relation to the second entity. For example, a sentence includes Entity C and states that Entity A has Relation A with Entity B (Entity C and Entity A are of same entity type). A negative sample is generated from the sentence by defining a No-(Relation) by selecting Relation A, Entity A or Entity B, and Entity C to define the negative sample as No-(Relation A) for Entity C and Entity B (as Entity C and Entity A have the same entity type).

In another example, negative samples are generated using header context relationships. In this example a header comprises text including Entity A. A body corresponding to the header includes a sentence that Entity B has Relation A with Entity C. A negative sample is generated from the header and body by defining a No-(Relation) by selecting Relation A, Entity A, and Entity C to define the negative sample as No-(Relation A) for Entity A and Entity C (Entity A and Entity B share an entity type). Also, a negative sample is generated for a first sentence and a second sentence in a same header.

For example, negative samples are generated using cross-sentence relationships for a first entity, Entity A, a second entity, Entity B, and a third entity, Entity C. In this example, a No-(Relation) is generated for the first entity (A) and the second entity (B) linked though a relation R, where the first entity (A) appears in a first sentence, and the second entity (B) appears in a second sentence. The third entity (C) appears in the second sentence. The first entity (A) and the third entity (C) are of a same entity type. A negative relation is generated by defining a No-(Relation) by selecting Relation A, the third entity (C), and the second entity (B) to define the negative sample as No-(Relation A) for the third entity (C), and the second entity (B). In various embodiments, the first sentence and the second sentence are in a same body and/or same header.

Taxonomic sample selection outperforms the random negative sampling and positive sampling only. Taxonomy-based negative sampling provides better coverage of edge cases as compared to positive sampling or random negative sampling. By way of example, for the positive triple (Tom Cruise, starred in, Top Gun), a random sample (London, starred in, Top Gun) ignores the entity type(s) involved with the relation for the triple and uses an invalid entity type for the relation.

Regardless, in various embodiments, negative samples may be additionally or alternatively generated using random negative sampling and/or one or more alternative methods, or a combination of one or more methods including but not limited to the following:
Corrupting positive instances: Corrupting positive instances methods generate negative instances by corrupting positive instances. For example, a sample including an entity “arm” is mutated by changing a letter to result in a negative sample “xrm”. Typed Sampling: Typed sampling methods determine relevant negative candidates (sources or targets) mined by constraining the entities to belong to the same type as that of the source (or target). Relational Sampling: Relational sampling methods assume that source target pairs participate in a particular relation, then generate negative samples based on relations other than the particular relation. Nearest Neighbor sampling: Nearest Neighbor sampling is performed by using a negative sampling model to generate negative samples that are close to a positive sample in a vector space. A similarity score or range is used to discriminate between positives and negatives that are very similar to the positives using vector analysis. Hard Negative Instance Sampling: Hard negative instance sampling is performed by random selection based on ground truth negative samples, such as by randomly selecting entities and relations from the negative samples as new negative samples and passing them through a relation extraction model; and choosing those samples which are predicted and/or known to be false.

The system determines if the taxonomic negative sample meets a sieving criterion (Operation 220). In various embodiments, one or more negative samples are evaluated using one or more sieving criteria to determine whether the one or more negative samples are included in a training data set. For example, if a negative sample includes a first entity and a second entity having a particular relation matching an entry in a knowledge base or other information source, the negative sample is not included as training data.

For example, in the case that a first drug is being administered at a first dosage and a second drug is being administered in a second dosage, A No-(Relation) corresponding to the relation (e.g., “No-DOSAGE_STRENGTH_OF_MEDICINE” corresponding to “DOSAGE_STRENGTH_OF_MEDICINE”) is generated by selecting the first dosage and the second drug. However, an information source, such as a medical ontology or database, includes the first dosage as a valid dosage for the second drug. Thus, the negative sample for the first dosage and the second drug is not used as training data because the first dosage is valid for the second drug. In various embodiments, various rules are used to filter or sieve negative samples prior to inclusion of the samples as training data.

If the taxonomic negative sample does meet the sieving criteria, the system selects a different first entity, a different second entity, and/or a different relation for a taxonomic negative sample (Operation 222). In embodiments, the taxonomic negative sample is “sieved” or discarded if the sample meets certain criteria, such as in the case that the taxonomic negative sample matches a known positive sample or other data point. In some embodiments, taxonomic negative samples are generated until a desired number is generated.

If the taxonomic negative sample does not meet the sieving criteria, the system stores the taxonomic negative sample (Operation 224). The samples are stored individually and/or in one or more sets of training data. In some embodiments, negative samples are classified, managed, and/or otherwise handled by a negative sample handler. For example, the negative samples are clustered, grouped, or flagged in response to analysis of the samples. In some cases, negative samples corresponding to edge cases or false negatives are identified and/or flagged for review.

The system builds a training data set using one or more positive samples and one or more taxonomic negative samples (Operation 226) In embodiments, a training data set generator selects a number of positive samples and a number of negative samples. In various embodiments, an equal number of positive and negative samples is selected. In other embodiments, the number of positive samples and negative samples is unequal, such that relatively more positive samples or relatively more negative samples are selected.

The system trains a machine learning model using the training data set (Operation 228). For example, the system accesses the training data, including the positive and taxonomic negative samples. The training data set is used to initialize, define, and/or update one or more parameters of a machine learning model. The process involves passing the training data, labeled with respect to the entities and relations, through the model, and then adjusting the model weights based on a loss function that measures the difference between the model's predicted relations and the actual relations in the data. This operation results in a trained machine learning model (e.g., language model, prediction engine, or the like) that can be used to infer relations between entities included with subsequent input into the model.

The system infers the presence of relations between entities using the trained machine learning model (Operation 230). For example, the trained model generates a binary answer indicating whether a particular relation is predicted to exist for a first entity and a second entity based on the trained model being provided the first entity, the second entity, and the particular relation. In this example, the system processes a query and/or one or more new records, and the system applies the trained machine learning model to the query and/or the one or more new records. In embodiments, the system extracts entities and relations from a new record. The trained model evaluates spans of text within the new record and predicts subject entities, object entities, and/or relations. The result of this operation is a set of inferred relations for entities in the data.

The system receives feedback regarding the validity of the presence of relations between entities inferred by the model (Operation 232). Various feedback mechanisms, such as a user input-based or an automated validation process, provide an indication of whether the inferred relations are accurate. For example, the feedback in the form of labels that confirm or refute the relationships predicted by the model is collected and prepared for use in fine-tuning the system's weights, parameters, and/or hyperparameters.

The system fine-tunes an entity extractor, a relation extractor, and/or the machine learning model using the feedback (Operation 234). In this example, the system uses the feedback to adjust the parameters of an entity extractor, a relation extractor, or the machine learning model. The feedback indicates incorrect extractions and/or incorrect relations, providing information that the system uses to recalibrate or update models used for extracting, identifying, and/or detecting entities and/or relations. The fine-tuning process enhances the accuracy of such models by reducing errors and refining the models'understandings of entities and/or relations in the data.

For example, during an initial training phase, a prediction engine is trained using records having labeled spans wherein entities, entity types, object spans, subject spans, other spans, relationships, and/or relationship types are annotated. The model's performance is evaluated based on metrics, such as precision, recall, and/or F1 score, by comparing the model's predictions to the ground truth in the labeled data. The discrepancies between predicted and actual outcomes are used to compute a loss function, which the model uses to adjust its internal parameters through methods like backpropagation.

During fine-tuning, feedback from previous results is used to improve the prediction engine. For example, if the prediction engine is deployed in a cloud environment, users of the cloud environment provide feedback by indicating whether the prediction engine result was positive or negative. This user feedback, and/or new annotated examples, are used train the prediction engine by fine-tuning the model's weights. This feedback is also provided to the entity extractor and/or the relation extractor, providing an indication of whether entities and/or relations were correctly extracted. Feedback for new results is collected in an iterative feedback loop that allows the extractors to continuously improve as they are exposed to new data and/or human input (i.e., positive or negative user feedback).

### 4. Example Techniques for Predictive Engine Training Using Taxonomic Negative Sampling

i. Example Taxonomic Negative Sample Generation From Documents

In an example, the model training system accesses a plurality of structured documents from one or more data sources. For example, approximately five thousand (5000) records are annotated with seventeen (17) entity types and eighteen (18) relation types, although any numbers of records, entity types and/or relation types can be used. Various example entity types include, but are not limited to: role, medicine name, diagnosis, sign, symptom, anatomical site, date, time, medicine name, body structure, modifier, medicine dosage, medicine strength, route, mode, frequency, disorder, finding, severity level, regime of therapy, null, etc. Various example relation types include, but are not limited to: Anatomical site of sign, date of symptom, dosage of medicine, route of medicine, mode of medicine, frequency of medicine, body structure of finding, modifier of body structure, body structure of disorder, modifier of disorder, modifier of regime of therapy, anatomical site of diagnosis, etc. In the example, the text is annotated with recorded instances of relationships between labeled entities. The negative instances are mapped to language model tokens of the training data using the vocabulary for the entity types consistent with the taxonomy of types defined by the relations.

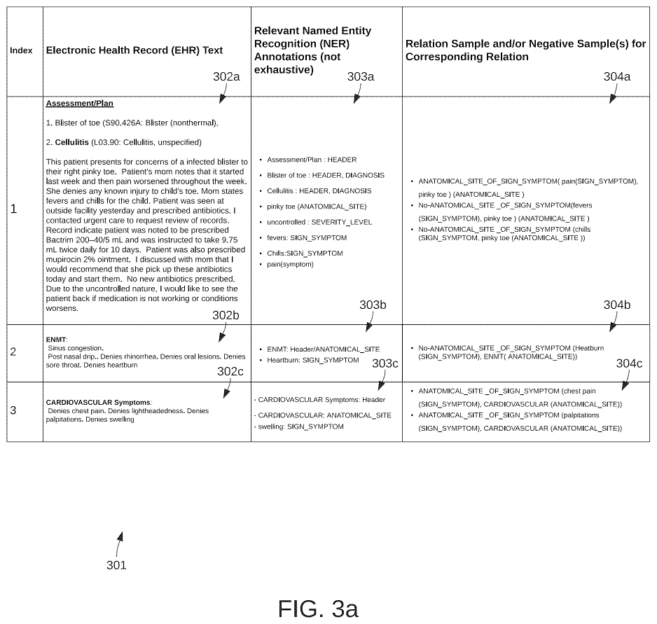

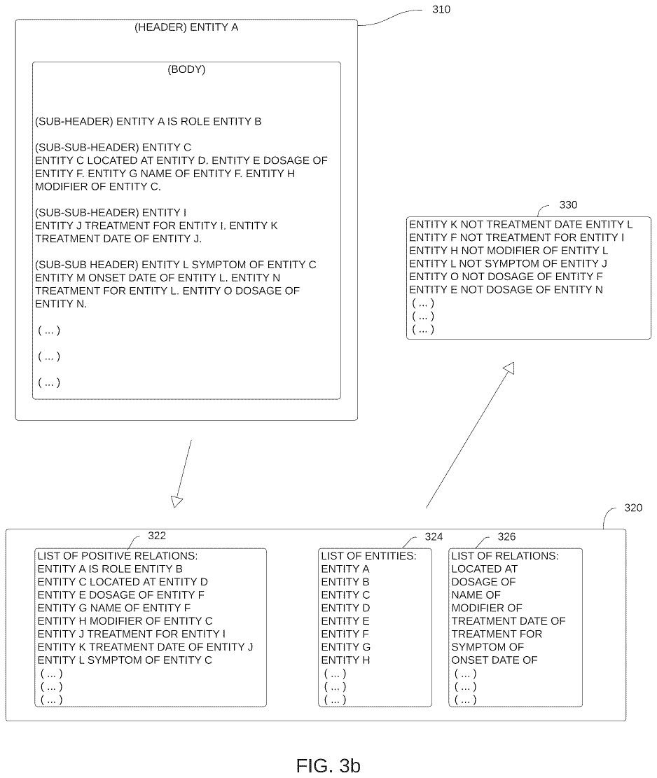

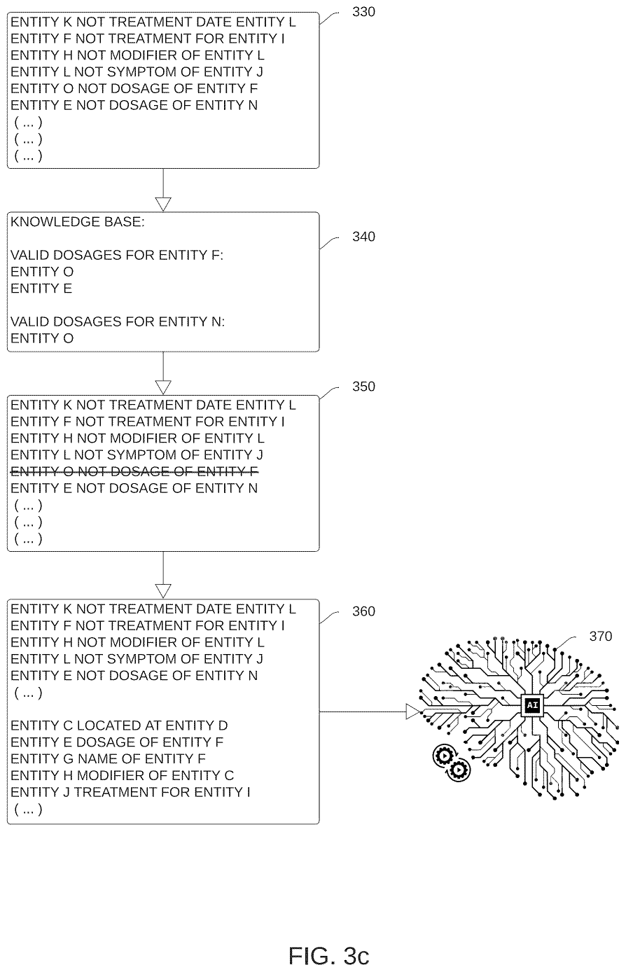

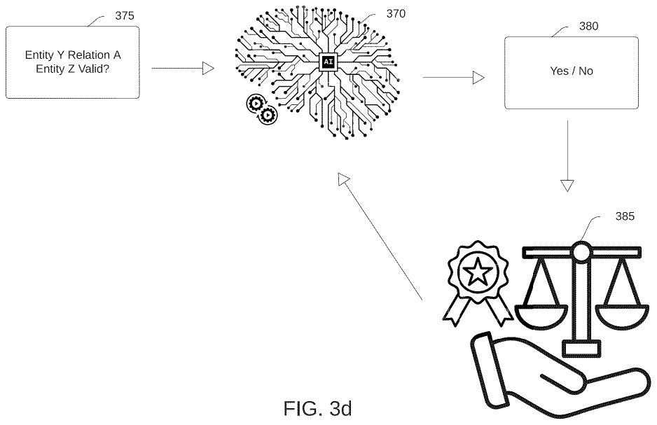

As illustrated in FIG. 3a, the system accesses a plurality of records which includes electronic health record (EHR) data 301. In FIG. 3a, a first chunk of EHR text 302a, a second chunk of EHR text 302b, and a third chunk of EHR text 302c include, respectively and non-exhaustively, a first set of relevant named entity annotations 303a, a second set of relevant named entity annotations 303b, and a third set of relevant named entity annotations 303c. In the example, the annotations reference a plurality of entities, and a plurality of annotations for the entities. The annotations include an indication of whether an entity appears in a body or header. The annotations include an indication of an entity type for an entity present in an EHR chunk. A first set of positive and/or negative samples 304a, a second set of positive and/or negative samples 304b, and third set of positive and/or negative samples 304c is generated based on the sets of relevant named entity annotations 303a, 303b, 303c.

In FIG. 3b, a record 310 includes a header referencing Entity A and a body. The body includes sub-headers and/or sub-sub-headers for sections of the body. In FIG. 3b, the example includes recognized named entities and relations between the recognized named entities. In various embodiments, an ontology of entities and/or relations is standardized and/or predetermined. In the example, the text of the record 310 is as follows:
(HEADER) ENTITY A
(BODY)
(SUB-HEADER) ENTITY A IS ROLE ENTITY B
(SUB-SUB-HEADER) ENTITY C
ENTITY C LOCATED AT ENTITY D. ENTITY E DOSAGE OF ENTITY F. ENTITY G NAME OF ENTITY F. ENTITY H MODIFIER OF ENTITY C.
(SUB-SUB-HEADER) ENTITY I
ENTITY J TREATMENT FOR ENTITY I. ENTITY K TREATMENT DATE OF ENTITY J.
(SUB-SUB HEADER) ENTITY L SYMPTOM OF ENTITY C
ENTITY M ONSET DATE OF ENTITY L. ENTITY N TREATMENT FOR ENTITY L. ENTITY O DOSAGE OF ENTITY N.

By way of further example, this text indicates Entity A has relation “is a role of” with Entity B (for example entity A is a client type Entity); Entity C is located at a location type entity D (for example Entity C is a hospital located in a particular city); Entity E is a dosage of entity F; Entity G is a name of entity F; Entity H is a modifier of Entity C; and so forth.

In the example, the record 310 is parsed into a data set 320 comprising a list of positive samples 322, a list of entities 324 and/or a list of relations 326. The system uses one or more extractors to extract entities and/or relations from the record 310.

The system generates a set of taxonomic negative samples 330 from the data set 320. In various embodiments, the system generates a number of negative samples [i.e., “No-(Relation)”] samples based on the list of positive samples, 322, the list of entities 324, the list of relations 326 by selecting one or more entities from the list of entities 324 and/or a relation from the list of relations 326 for which a corresponding positive sample is not present in the list of positive samples 322. In some embodiments, the system generates and/or selects a number of taxonomic negative samples equal to a number of positive samples included in a data set. However, in other examples, the system generates a number of negative samples which is k times the number of positive samples, or the system selects a different number or ratio of negative samples. In various embodiments, entities and negated relations are selected randomly, algorithmically, and/or manually to generate the negative samples.

ii. Example Entity and Relation Selection for and Sieving of Taxonomic Negative Samples
a. Entity and Relation Selection

With reference to FIGS. 3a-c, in some embodiments, a set of taxonomic negative samples 330 is selected and/or sieved such that certain samples are removed from the set of taxonomic negative samples 330. For example, some samples are removed based on information such as information contained in a knowledge base 340 or another reference source.

With reference to FIGS. 3a-c, negative sampling is performed by sampling labelled data to capture data points as pairs of the form: Relation(subject entity span, object entity span), with entity spans mapped to entity types, and relations to relations defined in the appropriate vocabulary. These data sets contain positive instances.

In the example, negative instances are not marked (or annotated) in the data. The task of relation in NLP is improved by including negative instances in training data. Improvement is further improved using a balance of positive and negative samples.

In the sample EHR data 301 of FIG. 3a, a header of the first chunk of EHR text 302a includes the text “Assessment/Plan” and a body of text for the header including the text “1. Blister of toe (S90.426A: Blister (nonthermal), 2 Cellulitis (L03.90: Cellulitis, unspecified)” In the example, a body of the first chunk of EHR text 302a includes the following text:

“This patient presents for concerns of a infected blister to their right pinky toe. Patient's mom notes that it started last week and then pain worsened throughout the week. She denies any known injury to child's toe. Mom states fevers and chills for the child. Patient was seen at outside facility yesterday and prescribed antibiotics. I contacted urgent care to request review of records. Record indicate patient was noted to be prescribed Bactrim 200-40/5 mL and was instructed to take 9.75 mL twice daily for 10 days. Patient was also prescribed mupirocin 2% ointment. I discussed with mom that I would recommend that she pick up these antibiotics today and start them. No new antibiotics prescribed. Due to the uncontrolled nature, I would like to see the patient back if medication is not working or conditions worsens.”

The following annotations, separated by semicolons, are determined for the first chunk of EHR text 302a: Assessment/Plan: HEADER; Blister of toe: HEADER, DIAGNOSIS; Cellulitis: HEADER, DIAGNOSIS; pinky toe (ANATOMICAL_SITE); uncontrolled: SEVERITY_LEVEL; fevers: SIGN_SYMPTOM; Chills: SIGN_SYMPTOM; pain(symptom).

The following are positive example instances the relation “ANATOMICAL_SITE_OF_SIGN_SYMPTOM” and taxonomic negative samples for relations of the same type as the example instances for the first chunk of EHR text 302a: ANATOMICAL_SITE_OF_SIGN_SYMPTOM(pain(SIGN_SYMPTOM), pinky toe) (ANATOMICAL_SITE); No-ANATOMICAL_SITE _OF_SIGN_SYMPTOM(fevers (SIGN_SYMPTOM), pinky toe ) (ANATOMICAL_SITE); No-ANATOMICAL_SITE_OF_SIGN_SYMPTOM (chills (SIGN_SYMPTOM, pinky toe (ANATOMICAL_SITE)).

In the sample EHR data 301 of FIG. 3a, a header of the second chunk of EHR text 302b includes a header with text “ENMT:” and a body with text “Sinus congestion Post nasal drip.. Denies rhinorrhea. Denies oral lesions. Denies sore throat. Denies heartburn”

The following annotations are determined for the second chunk of EHR text 302b: ENMT: Header/ANATOMICAL_SITE; Heartburn: SIGN_SYMPTOM.

The following is a taxonomic negative sample for a “ANATOMICAL_SITE_OF_SIGN_SYMPTOM” relation for the second chunk of EHR text 302b: No-ANATOMICAL_SITE OF_SIGN_SYMPTOM (Heartburn (SIGN_SYMPTOM), ENMT(ANATOMICAL_SITE)).

In FIG. 3a, a header of the third chunk of EHR text 302c includes the text “CARDIOVASCULAR Symptoms:” and a body including the text “Denies chest pain. Denies lightheadedness. Denies palpitations. Denies swelling”

The following annotations are determined for the third chunk of EHR text 302c: CARDIOVASCULAR Symptoms: Header; CARDIOVASCULAR: ANATOMICAL_SITE; swelling: SIGN_SYMPTOM.

The following are positive example instances for a relation “ANATOMICAL_SITE_OF_SIGN_SYMPTOM” and taxonomic negative samples for relations of the same type for the third chunk of EHR text 302c: ANATOMICAL_SITE_OF_SIGN_SYMPTOM (chest pain (SIGN_SYMPTOM), CARDIOVASCULAR (ANATOMICAL_SITE)); ANATOMICAL_SITE_OF_SIGN_SYMPTOM (palpitations (SIGN_SYMPTOM), CARDIOVASCULAR (ANATOMICAL_SITE)); No-ANATOMICAL_SITE_OF_SIGN_SYMPTOM (swelling (SIGN_SYMPTOM), CARDIOVASCULAR (ANATOMICAL_SITE)).

In the example, while performing negative sampling for relations the text is annotated with possible true instances of one or more example relationships between labelled entities (which are mapped to tokens). Negative instances of relations are selected that are not annotated in the original labelled data. These negative relations are formed in accordance with the relationship vocabulary that comes with the data set (that is, these relations are formed between entity types which are valid and allowed by the medical ontology or other annotation guidelines). In some cases, as many negative instances of relations are selected as there are positive samples in a dataset.

b. Sieving of Taxonomic Negative Samples

Selected negative samples that are selected using a taxonomy-driven approach are refined by sieving them to generate a “shortlist” of sieved negative samples. The shortlist is provided to the relation prediction model to generate hard negative instances (i.e., one or more negative samples which are predicted to be false by a relation prediction model trained using the shortlist and positive samples).

In some cases, a set of negative samples are generated from a sample corpora, out of which some of the negative samples are actually positive samples globally irrespective of contexts considered. Such occurrences are eliminated from via sieving to result in a sieved set of negative samples. In the example, the sieving process uses a medical ontology for filtering.

The following is an example of EHR data that is annotated: Advised Telmisartan (Medicine_name) 40 mg (Medicine_strength) OD (Medicine_freq) PO (Medicine_route), Atorlip (Medicine_name) 5 mg (Medicine_strength) OD (Medicine_freq) PO (Medicine_route), Febuxostat (Medicine_name) 20 mg (Medicine_strength) OD (Medicine_freq).

This annotations for the text having the following relationships are defined using an ontology or guideline to define the relationships.

STRENGTH_OF_MEDICINE (Telmisartan, 40 mg); DOSAGE_OF_MEDICINE (Telmisartan, OD); ROUTE_MODE_OF_MEDICINE (Telmisartan, PO); STRENGTH_OF_MEDICINE(Atorlip, 5 mg); DOSAGE_OF_MEDICINE(Atorlip, OD); ROUTE_MODE_OF_MEDICINE (Atorlip, PO); STRENGTH_OF_MEDICINE (Febuxostat, 20 mg); DOSAGE_OF_MEDICINE (Febuxostat, OD); etc.

Using a taxonomy-driven approach, the following negative samples are selected: No-STRENGTH_OF_MEDICINE (Atorlip, 40 mg); No-STRENGTH_OF_MEDICINE (Telmisartan, 5 mg); and No-STRENGTH_OF_MEDICINE (Telmisartan, 20 mg).

However, STRENGTH_OF_MEDICINE (Telmisartan, 20 mg) is a valid relation instance as Telmisartan is prescribed with a dosage of 20 mg for hypertensive patients. This information is determined based on data from a knowledge base and/or another document.

To prevent valid relations from being considered as negative samples, the following sieve procedure is applied: From a corpus of EHR documents with annotated relations, negative samples are selected using a taxonomy driven approach. An ontology (e.g. a medical or other ontology defining a structure of relations and entity types for relations) is accessed and/or used to define one or more taxonomies of relations.

In the example, an ontology for relations involving Medicine_name is used. The relations involving Medicine_name include the following: STRENGTH_OF_MEDICINE, DOSAGE_OF_MEDICINE, and/or ROUTE_MODE_OF_MEDICINE. An example ontology can be formed using public information available on the world wide web at https://www.mims.com/india (available as of Dec. 02, 2024). After a first round of sieving, the system performs a check for whether a sample in a present collection of negative samples is in the accessed ontology. Responsive to a negative sample being included in an ontology, the negative sample is discarded (e.g., deleted and/or not included in the sieved set).

For example, the knowledge base 340 of FIG. 3c includes names and/or rules for entities and relations that determine whether a relation is valid or invalid. For example, a taxonomic negative sample (e.g., “ENTITY O NOT RELATION_NAME OF ENTITY F”) is identified by the system because the knowledge base includes a positive ground truth corresponding to the taxonomic negative sample (e.g., ENTITY O RELATION_NAME OF ENTITY F is valid according to the ground truth knowledge).

For a count or number n of positive taxonomic instances in the records, an equal number m of taxonomic negative samples is selected, including a number of samples x for relationships occurring in same-sentence context, a number of samples y for relationships occurring in cross-sentence context, and a number of samples z for relationships in a header associated context. In the example, the number of negative instances is the sum of the number of samples for relationships occurring in same-sentence context, the number of samples for relationships occurring in cross-sentence context, and the number of samples for relationships in a header associated context (e.g., m=x+y+z).

In an embodiment, the system generates all the negative samples that are possible to be formed from a sentence using negated relations. In embodiments, two times the number of relationships occurring in same-sentence context (2x) for the positive samples are selected for the negative samples. In other embodiments, another number of same-sentence negative samples is selected.

In an embodiment, the system generates all the negative samples that are possible to be formed from across sentences using negated relations. In embodiments, two times the number of relationships occurring in cross-sentence context (2y) for the positive samples are generated and/or selected for the negative samples. In other embodiments, another number of cross-sentence negative samples is selected.

In an embodiment, the system generates all the negative samples that are possible to be formed from across header context and body context using negated relations. In embodiments, two times the number of relationships occurring in header context (2z) for the positive samples are generated and/or selected for the negative samples. In other embodiments, another number of header context samples is selected.

The system sieves the negative random taxonomic samples via a sieve process as follows: The system filters out a number M that is less than total number of negative samples to result in m′ samples [(m−m′=M≤2(x+y+z) negative samples].

If the number of negative samples is larger than the number of positive samples after sieving (if m−M=m′>n), the system randomly selects a number of the taxonomic negative samples and uses the selected taxonomic negative samples for inclusion in the training data set along with the number of positive samples from the records.

In various other embodiments, models are trained on data sets with different ratios of positive and negative samples (i.e., of n and m′), and/or with different ratios for the types of samples (i.e., for x, y, and z).

If the number of taxonomic negative samples after sieving is not larger than the number of positive samples, the system identifies a number of taxonomic negative samples to generate according to a relation class. For example, sieving results in a number (m′) of taxonomic negative samples including a number (x′) of sieved negative samples for same-sentence context, a number (y′) of sieved negative samples for cross-sentences context, and a number (z′) of negative samples in a header context (i.e., m′=x′+y′+z′). In this case, a number of taxonomic negative samples for a class is selected based the number of negative samples for that class that were sieved from the set. For example, a number of single-sentence context taxonomic negative samples is randomly selected based on the number of positive single-sentence context samples and the difference in the number of desired single-sentence context taxonomic negative samples and the number of single-sentence context taxonomic negative samples in the sieved set (x−x′). In embodiments, the system also selects a number of cross-sentence context taxonomic negative samples randomly based on the number of positive cross-sentence context samples and the difference in the number of desired cross-sentence context taxonomic negative samples and the number of cross-sentence context taxonomic negative samples in the sieved set (y−y′) and/or selects a number of header context taxonomic negative samples randomly based on the number of header context samples and the difference in the number of header context taxonomic negative samples and the header context taxonomic negative samples in the sieved set (z−z′). In this example, the resulting number of negative samples will be equal to the number of positive that is for each class of relation (i.e., same-sentence, cross-sentence, or header context), or to another number is desired.

A sieved negative sample set 350 is combined with positive samples to result in training data set 360. The training data set 360 is used to train a machine learning model 370, (i.e. a prediction engine 370). The training process utilizes the data to learn patterns and relationships relevant to a prediction task. For instance, a model trainer adjusts model parameters to optimize performance based on the provided samples. The resulting prediction engine 370 is capable of making predictions based on subsequent received input.

iii. Example Negative Sample Sieving Process

In an example, taxonomic negative samples are generated based on a sample corpora, out of which some of the taxonomic negative samples are actually positive samples or global positive samples. A medical ontology is used for filtering negative samples to rule out such occurrences. An example of such a process is explained with reference to the example EHR text below.

Example EHR text:
Advised Telmisartan (Medicine_name) 40 mg (Medicine_strength) OD (Medicine_freq) PO (Medicine_route), Atorlip (Medicine_name) 5 mg (Medicine_strength) OD (Medicine_freq) PO (Medicine_route), Febuxostat (Medicine_name) 20 mg (Medicine_strength) OD (Medicine_freq)

This text is annotated with the following relationships:
STRENGTH_OF_MEDICINE (Telmisartan, 40 mg), DOSAGE_OF_MEDICINE (Telmisartan, OD), ROUTE_MODE_OF_MEDICINE (Telmisartan, PO), STRENGTH_OF_MEDICINE(Atorlip, 5 mg), DOSAGE_OF_MEDICINE(Atorlip, OD), ROUTE_MODE_OF_MEDICINE (Atorlip, PO), STRENGTH_OF_MEDICINE (Febuxostat, 20 mg), DOSAGE_OF_MEDICINE (Febuxostat, OD), and so forth.

Taxonomic negative sampling, a plurality of taxonomic negative samples are generated, including the following:
No-STRENGTH_OF_MEDICINE (Atorlip, 40 mg), No-STRENGTH_OF_MEDICINE (Telmisartan, 5 mg), No-STRENGTH_OF_MEDICINE (Telmisartan, 20 mg)

In this example, STRENGTH_OF_MEDICINE (Telmisartan, 20 mg) is a valid relation instance as Telmisartan is often prescribed with a potency of 20 mg for hypertensive patients. For example, a knowledge base or other data source includes information about valid relations that is used as a basis of comparison for identifying taxonomic negative samples that are positives.

For example, given a corpus of EHR documents with annotated relations, a set of negative samples are selected using a taxonomy driven approach such as taxonomic negative sampling. A medical ontology is used to define relevant names entities. Example ontologies include relations involving Medicine_name such as STRENGTH_OF_MEDICINE, DOSAGE_OF_MEDICINE, ROUTE_MODE_OF_MEDICINE. This and/or other ontologies can be formed using publicly available information. For example, one or more medical ontologies are accessed using a networked internet connection. In the example, after negative taxonomic samples are generated and/or after one or more rounds of sieving, remaining taxonomic negative samples are compared to the one or more ontologies. Responsive to taxonomic negative sample being indicated as a positive sample by the ontology, the negative taxonomic sample is discard from the set of negative samples.

iv. Example Reward Model for Prediction Engine Training and/or Fine-Tuning

In FIG. 3d, the prediction engine 370 generates a response 380 based on an input 375. For example, the input includes an identification of a relation for a first entity and a second entity. The prediction engine 370 predicts whether the relation is valid for the first entity and the second entity by outputting a binary indicator or other response. A reward model 385 determines if the prediction in the response 380 is valid. The reward model 385 provides rewards and/or other feedback for the prediction in the response 380 to the machine learning model 370, to improve the prediction engine 370.

For example, the reward model 385 performs reward-based training and/or finetuning on the prediction engine 370 to refine predictions based on feedback for the predictions. After the prediction engine generates a response, the reward model evaluates the accuracy of the response. This evaluation is based on various forms of feedback, such as comparing the prediction to known ground-truth data, receiving user feedback, or using domain-specific rules. The reward model determines whether the prediction correctly represents the relationship between the entities. If the prediction is valid, the reward model confirms this, reinforcing the outcome with a positive reward. If the prediction is incorrect, the reward model provides negative feedback or no reward, indicating that the prediction engine needs 370 to adjust a corresponding parameter. This adjustment is then used to generate additional responses, and more feedback is accessed, evaluated, and used to improve the prediction engine 370. Through this continuous loop of prediction, evaluation, and feedback, the system refines its ability to accurately make predictions.

v. Example Batch Balancing

In embodiments, the system performs batch balance during training and/or fine-tuning of the machine learning model. In embodiments, the system provides batches of positive and negative samples in ratios to a machine learning algorithm to determine, such as by determining a critical point via gradient descent, an optimal balance of positive and negative samples used during training and/or fine-tuning.

### 5. Machine Learning Architecture

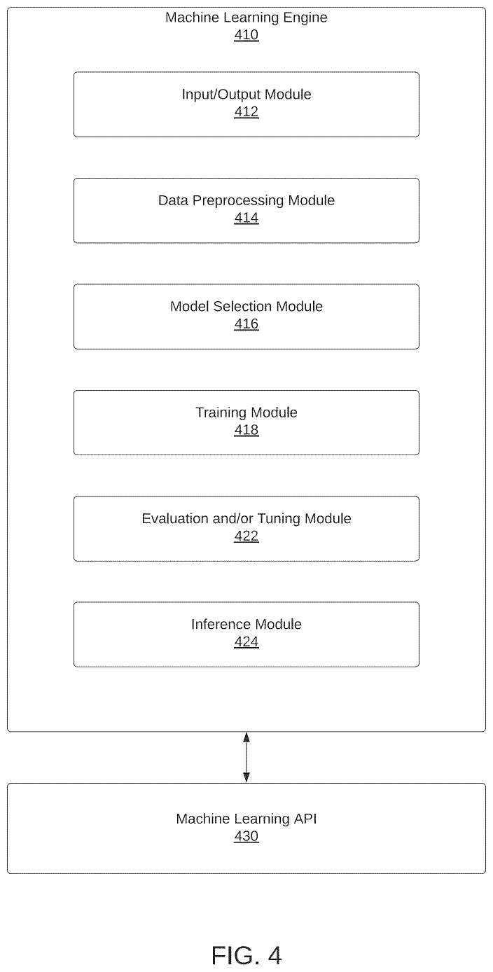

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training ML models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

### 6. Machine Learning Operations

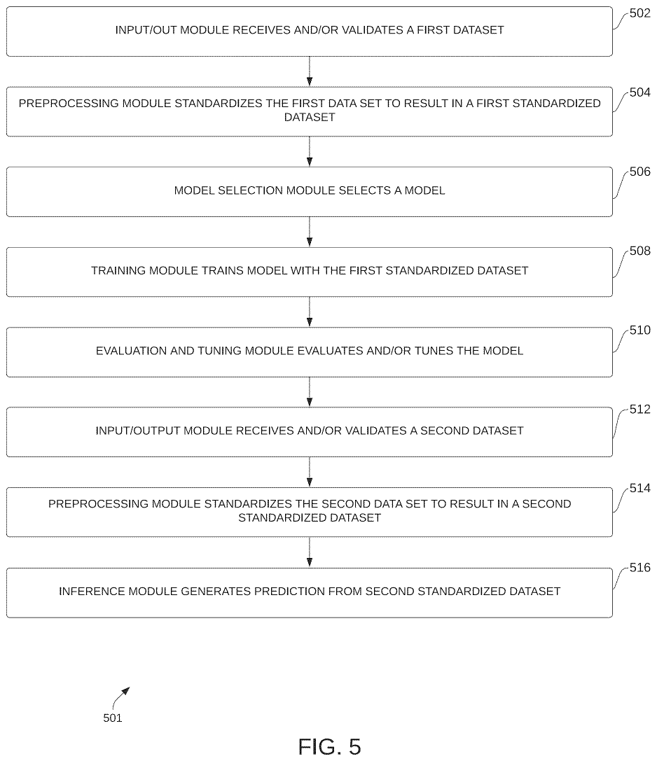

FIG. 5 illustrates a set of machine learning operations 500. In embodiments, one or more operations of the set of operations 500 is performed by a machine learning engine such as machine learning engine 400. In an embodiment, input/output module 420 receives a dataset intended for training (Operation 502). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 422 is then fed into model selection module 424 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 508). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 510). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 512).

In an embodiment, data preprocessing module 422 receives the validated dataset intended for inference (Operation 514). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 516). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 7. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a taxonomic negative sampling-based machine learning system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

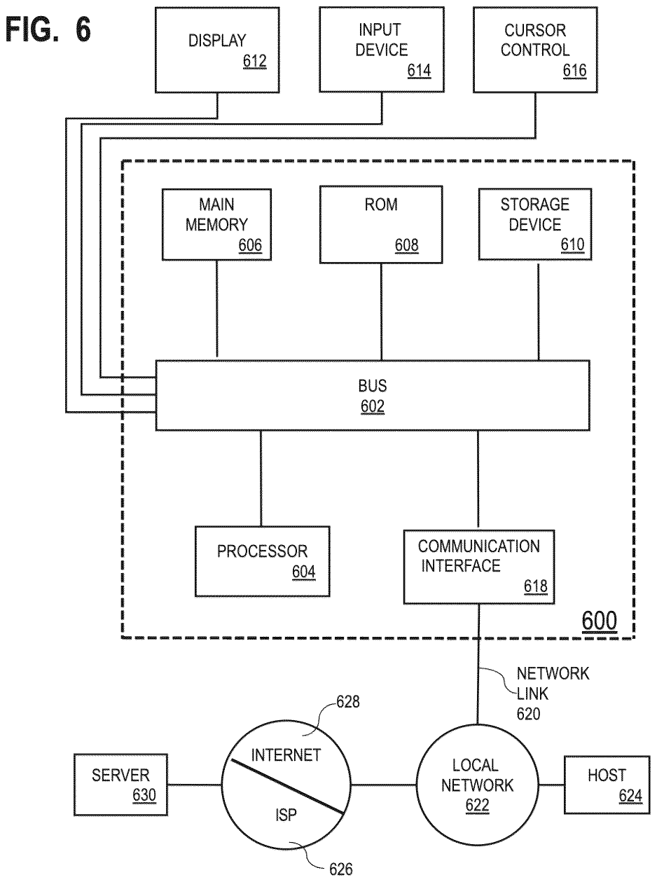

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A method, comprising:
defining a negative sample from a data set by:
generating a vocabulary of entities and a vocabulary of relations from the data set by identifying a plurality of entities and one or more relations included in the data set, the relations comprising a relation between a first entity and a second entity of the plurality of entities;
selecting, from the vocabulary, a first entity, a second entity, and a relation which does not exist for the first entity and the second entity in the vocabulary to generate a negative sample for the data set; and
providing the negative sample as training data to a model.

2. The method of claim 1, comprising:
adding the negative sample to a training data set including a positive sample of the data set; and
providing the training data set as training data for the model.

3. The method of claim 1, comprising
generating the vocabulary by extracting entities and relations from annotated documents of the data set using sets of spans of the annotated documents.

4. The method of claim 3, wherein
the entities are extracted from sets of spans having entity types and relations between entities mapped to spans of one or more sentences.

5. The method of claim 1, wherein
the vocabulary comprises header context relationships and body context relationships; the header context relationships comprising a relationship between a first entity in a header for a body and a second entity in the body, and the body context relationships comprising a relationship between a third entity in the body and a different entity in the body.

6. The method of claim 5, wherein the body context relationships comprise a single sentence relation and a cross-sentence relation.

7. The method of claim 1, wherein
the negative sample is generated from a structured document of the data set using a structure of the structured document to define relationships between entities, the structure including one or more headers and one or more bodies.

8. The method of claim 1, wherein
a negative sample is generated from a standardized medical document by selecting, from the standardized medical document, a first medical term, a second medical term not having a particular medical relation with the first medical term, and the particular medical relation for the negative sample.

9. The method of claim 8, wherein
the first medical term and the second medical term are selected from: role, medicine name, diagnosis, sign, symptom, anatomical site, date, time, medicine name, body structure, modifier, medicine dosage, medicine strength, route, mode, frequency, disorder, finding, severity level, regime of therapy, and null.

10. The method of claim 8, wherein
the particular medical relation is selected from a predetermined vocabulary.

11. The method of claim 10, wherein:
the predetermined comprises a list of relations including at least one of:
anatomical site of sign, date of symptom, dosage of medicine, route of medicine, mode of medicine, frequency of medicine, body structure of finding, modifier of body structure, body structure of disorder, modifier of disorder, modifier of regime of therapy, and anatomical site of diagnosis.

12. The method of claim 1, comprising
performing negative sampling using at least one of: random negative sampling, corrupting positive instances, typed sampling, relational sampling, nearest neighbor sampling, hard negative instance sampling, and taxonomic negative sampling.

13. The method of claim 1, wherein
the model is a relation prediction engine.

14. The method of claim 1, comprising
verifying the negative sample using a knowledge base by determining whether a positive instance corresponding to the negative sample exists in the knowledge base.

15. The method of claim 1, comprising
counting positive samples in the data set and generating a number of negative samples equal to a count of positive samples.

16. The method of claim 1, comprising
identifying an edge case or false positive in the data set and providing the edge case or false positive as training data to the model.

17. The method of claim 1, wherein:
the data set comprises a set of electronic health record documents having a structured content comprising one or more headers and one or more bodies.

18. The method of claim 17, comprising:
extracting entities and relationship by executing an entity extraction algorithm, the entity extraction algorithm comprising a definition for a set of entity types and relations, and the set of entity types and relations corresponding to standard entity types and standard relations for a standardized electronic health record format.

19. One or more non-transitory computer readable media comprising instructions which, when executed by one or more hardware processors, cause performance of operations comprising:
defining a negative sample from a data set by:
generating a vocabulary of entities and a vocabulary of relations from the data set by identifying a plurality of entities and one or more relations included in the data set, the relations comprising a relation between a first entity and a second entity of the plurality of entities;
selecting, from the vocabulary, a first entity, a second entity, and a relation which does not exist for the first entity and the second entity in the vocabulary to generate a negative sample for the data set; and
providing the negative sample as training data to a model.

20. A system, comprising:
at least one device including a hardware processor, the system being configured to perform operations comprising:
defining a negative sample from a data set by:
generating a vocabulary of entities and a vocabulary of relations from the data set by identifying a plurality of entities and one or more relations included in the data set, the relations comprising a relation between a first entity and a second entity of the plurality of entities;
selecting, from the vocabulary, a first entity, a second entity, and a relation which does not exist for the first entity and the second entity in the vocabulary to generate a negative sample for the data set; and
providing the negative sample as training data to a model.
